(19) United States
(12) Patent Application Publication
(10) Pub. No.: US 2004/0253981 A1
(43) Pub. Date: Dec. 16, 2004

(54) Cellular telephone print control system

(76) Inventors: Leo Robert Blume, Palo Alto, CA (US); Phillip A. McCoog, Portland, OR (US); Rabindra Pathak, Vancouver, WA (US); Michael Strittmatter, San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/463,381

(22) Filed: Jun. 16, 2003

(51) Int. Cl. H04M 1/38

(52) U.S. Cl. 455/552.1

(57) ABSTRACT

A print controller for a cellular telephone is provided. The print controller includes a memory configured to store a state associated with processing print data. The print controller also includes a print control logic configured to control the cellular telephone in (re)processing print data.

It is emphasized that this abstract is provided to comply with the rules requiring an abstract that will allow a searcher or other reader to quickly ascertain the subject matter of the application. It is submitted with the understanding that it will not be employed to interpret or limit the scope or meaning of the claims.

### TECHNICAL FIELD

The systems, methods, storage media and so on described herein relate generally to cellular telephones and more particularly to controlling print jobs associated with cellular telephones.

### BACKGROUND

Cellular telephones have conventionally had limited or no print capabilities. As cellular telephones acquire print capabilities, printing issues may arise like how to handle interrupted print jobs.

### BRIEF DESCRIPTION OF THE DRAWINGS

The accompanying drawings, which are incorporated in and constitute a part of the specification, illustrate various example systems, methods, and so on that illustrate various example embodiments of aspects of the inventions. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example print controller associated with a cellular telephone.

FIG. 2 illustrates an example print controller associated with a cellular telephone.

FIG. 3 illustrates an example print controller associated with a cellular telephone.

FIG. 4 illustrates an example image forming device that may interact with a print-enabled cellular telephone.

FIG. 5 illustrates an example method associated with processing print data in a cellular telephone.

FIG. 6 illustrates an example method associated with processing print data in a cellular telephone.

FIG. 7 illustrates a portion of an example method associated with processing print data in a cellular telephone.

FIG. 8 illustrates an example data packet associated with processing cellular telephone print data.

FIG. 9 illustrates an example cellular telephone.

FIG. 10 illustrates an example image forming device.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may fall within the definitions.

“Computer-readable medium”, as used herein, refers to a medium that participates in directly or indirectly providing signals, instructions and/or data. A computer readable medium may take forms, including but not limited to, non-volatile media, volatile media, and transmission media. Non-volatile media may include, for example, optical or magnetic disks and so on. Volatile media may include dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of computer-readable media include, for example, a floppy disk, a flexible disk, hard disk, magnetic tape, other magnetic medium, a CD-ROM, other optical medium, punch cards, paper tape, other physical medium with patterns of holes, a RAM, a ROM, a PROM, an EPROM, a FLASH-EPROM, or other memory chip or card, a memory stick, a carrier wave/pulse, or other media from which a computer, a processor or other electronic device can read. Signals used to propagate instructions or other software over a network, such as the Internet, are also considered a “computer-readable medium.”

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to one or more electrical signals, analog or digital signals, one or more computer or processor instructions, messages, a bit or bit stream, or other means that can be received, transmitted, and/or detected.

“Software”, as used herein, includes but is not limited to one or more computer readable, interpretable, compilable, and/or executable instructions that cause a computer or other electronic device to perform functions, actions, and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local or remote), a servlet, an applet, instructions stored in a memory, part of an operating system or browser or other type of executable instructions. It will be appreciated by one of ordinary skill in the art that the form of software may be dependent on, for example, requirements of a desired application, the environment it runs on, and/or the desires of a designer/programmer or the like. It will also be appreciated that computer readable and/or executable instructions can be located in one logic and/or distributed between two or more communicating, co-operating, and/or parallel processing logics and thus can be loaded and/or executed in serial, parallel, massively parallel and other manners.

“User”, as used herein, includes but is not limited to one or more persons, software, computers, logics, or other devices, or combinations of these.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, or similar electronic device that manipulates and transforms data represented as physical (electronic) quantities.

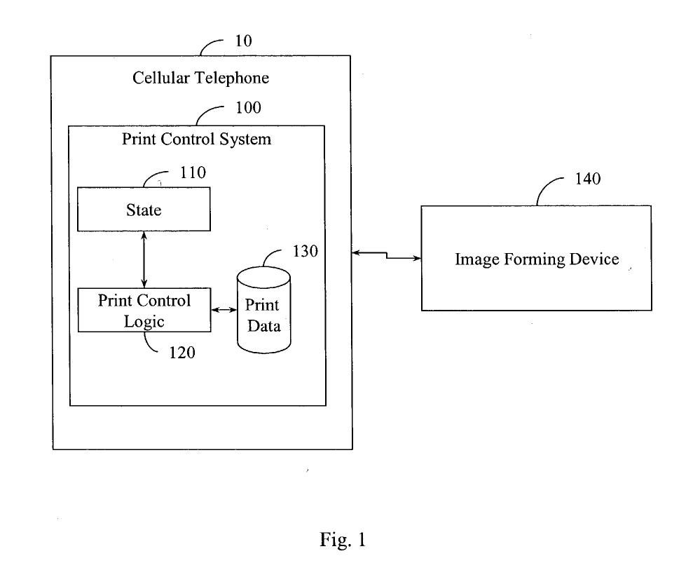

FIG. 1 illustrates an example cellular telephone 10 including an example print control system 100. The cellular telephone 10 may take a variety of forms and may include a variety of features. For example, the cellular telephone 10 may be a cellular device or a digital camera-enabled mobile phone. While the application described cellular telephones, it is to be appreciated that the systems and methods can be employed with other mobile devices like wireless network enabled personal digital assistants (PDA). The print control system 100 can be configured, for example, to determine whether processing associated with a print job associated with the cellular telephone 10 failed and if so, in which component(s) and/or at what point. The determination can in turn facilitate resuming a print job at an appropriate location, which may reduce processing and/or transmission time.

The print control system 100 may include a memory 110 configured to store a state associated with the cellular telephone 10 processing a set of print data 130. While the memory 110 is described, the state may also be stored, for example, in a data store, as well as other memories described herein. The memory 110 can be embodied as a computer-readable medium. Processing the set of print data 130 can include, but is not limited to, preparing the set of print data 130 to be transmitted to an image forming device 140, and transmitting the set of print data 130 to the image forming device 140. Preparing the set of print data 130 to be transmitted to an image forming device 140 can include producing “printer ready bits” that can be printed by, for example, a printer. Preparing the set of print data 130 may also include, for example, producing a file of “printer ready instructions” like PostScript and the like. Preparing the set of print data 130 to be transmitted to an image forming device 140 can also include preparing non-printer specific data in a printer independent format like vCard and vCal. Thus, it is to be appreciated that the print data 130 that is transmitted may be in printer ready format (e.g., bits, instructions) and/or in a form wherein the image forming device 140 will perform subsequent processing before the print data 130 is in printer ready form.

Transmitting the set of prepared print data 130 to an image forming device 140 can be performed by various means including, bit-wise, byte-wise, packet-wise, message-wise, instruction-wise, file-wise and so on. Thus, if a transmission is interrupted, various levels of granularity (e.g., bit, byte, message) may be selected for retransmitting the prepared print data 130. Furthermore, the print data 130 may be transmitted by methods including, but not limited to, wireless methods and wired methods via various protocols including, but not limited to, Bluetooth, IEEE 802.11, point-to-point, and so on. In one example, Bluetooth Image Protocol (BIP) can be employed as a connection protocol between two Bluetooth devices.

The state stored in the memory 110 may include information concerning a status of the preparation and/or transmission of the print data 130. For example, the state may store the extent to which the set of print data 130 has been prepared for transmitting to an image forming device 140. By way of illustration, the state may store information that a certain percentage (e.g., 10%, 25%, 99%) of the print data 130 has been prepared. Thus, if an interruption occurs during the preparation of the print data 130, the state may be queried to facilitate determining which of the print data 130 has been prepared and which of the print data 130 still requires preparing. The state may also store, for example, the extent to which the set of print data 130 has been transmitted to an image forming device 140, and the extent to which the set of print data has been formed into an image by an image forming device 140. By way of illustration, the state may store information that a certain percentage (e.g., 50%, 75%) of the prepared print data 130 has been transmitted to an image forming device 140. In some examples, where an image forming device 140 communicates state and/or status information back to the cellular telephone 10, the state may also store information concerning how much of the transmitted print data has been formed into an image. For example, a printer may report that fifteen pages of print data were received and that twelve pages were printed. Thus, the state may be queried to facilitate determining which print data, if any, should be retransmitted to the printer.

When transmitted, the print data 130 may not be transmitted directly to an image forming device 140. One or more communication components (e.g., switch, router, store and forward device, network controller, print spooler) may be located between the cellular telephone 10 and the image forming device 140. In some examples, one or more of these “downstream components” may be able to report state and/or status information to the cellular telephone print control system 100. Thus, the print control system 100 may be configured to store state information in the memory 110 associated with the status of one or more downstream components associated with forming the print data 130 into an image by an image forming device 140. While a single memory 110 may store the cellular telephone state and the downstream component state(s), the print control system 100 may include two or more memories and/or data stores for storing state(s).

The print control system 100 may also include a print control logic 120 configured to control the cellular telephone 10 to selectively reprocess a subset of the set of print data 130 based, at least in part, on the state stored in memory 110. The print control logic 120 may determine, for example, that while print data 130 is being prepared for transmission to an image forming device 140, a state saving event occurs like a battery on the cellular telephone 10 being low in power. Thus, a state save is triggered, the state of the preparation is saved in memory 110, and the preparation is halted. When, for example, a “battery okay” signal is received, the print control logic 120 may examine the state in memory 110 and control the cellular telephone 10 so that preparing the print data 130 for transmission to the image forming device 140 resumes where it left off. In another example, the print control logic 120 may determine that preparation was halted, but may not be able to determine where the preparation was halted. Thus, in this example, the print control logic 120 may direct the cellular telephone 10 to reprocess substantially all of the print data 130. It is to be appreciated that the print control logic 120 may direct the cellular telephone 10 to reprocess some, none, all, and/or substantially all of the print data 130 based, at least in part, on the state stored in memory 110.

The image forming device 140 may be, for example, a printer. Thus, in one example, the print data 130 may be data that is intended to be printed on a printer. It is to be appreciated, however, that the image forming device 140 may be a device other than a printer, for example, a display. In this example, the print data 130 may be data that is intended to be displayed on the display rather than printed on a printer. While a printer and a display are described, it is to be appreciated that the image forming device 140 and the print data 130 may take other forms and thus that the print control system 100 may handle interruptions of a variety of print data 130 between a variety of image forming devices 140.

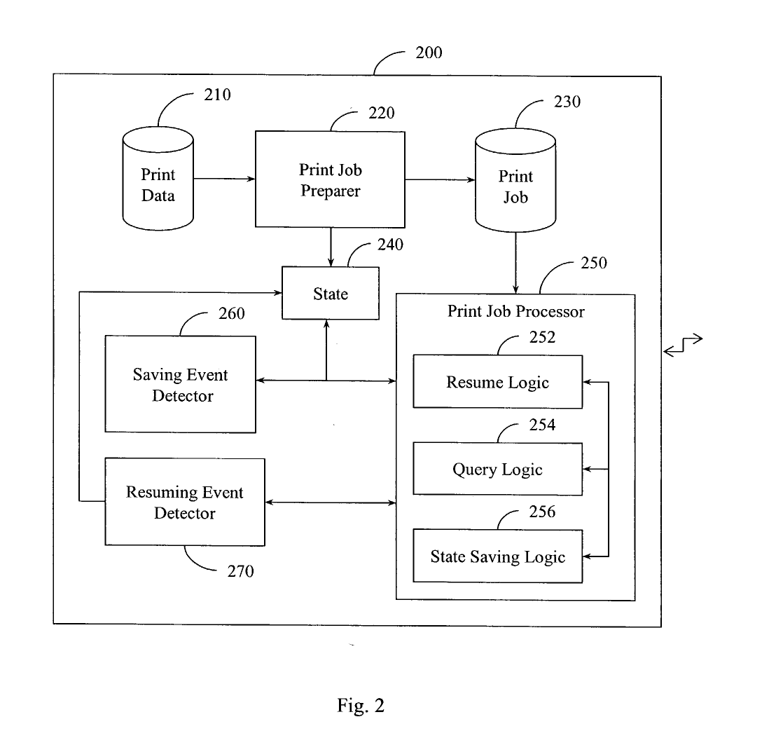

The print control logic 120 may include and/or interact with a saving event detector 260 (FIG. 2) that determines when a state associated with the cellular telephone 10 processing a set of print data 130 should be stored in the memory 110. Similarly, the print control logic 120 may include and/or interact with a resuming event detector 270 (FIG. 2) that determines when the print control logic 120 should control the cellular telephone 10 to selectively reprocess a subset of the set of print data 130.

Thus, turning to FIG. 2, an example print control system 200 associated with a cellular telephone is illustrated. A set of print data 210 (e.g., document, image, text, and the like) desired to be printed can be located on the cellular telephone. A print job preparer 220 can be configured to receive the set of print data 210 and to produce a print job 230. In one example, the print job 230 may include “printer ready bits” (e.g., rendered data) that are substantially ready to be formed into an image by an image forming device. The print job 230 may, additionally and/or alternatively, include printing instructions, data, and/or printer-independent data that an image forming device will further process. It is to be appreciated that the print job 230 may be destined for an image forming device like a printer or a display. Thus, the print job preparer 220 converts a first set of print data 210 that is not understandable or interpretable by an image forming device into a second set of print data 230 that is understandable by an image forming device and is ready to be transmitted to the image forming device. In one example, the cellular telephone acquires a print job 230 via, for example, a data communication, and thus the print job 230 may not be prepared by the print job preparer 220 located on the cellular telephone. Thus, in some examples, the print control system 200 may not include a print job preparer 220. It is to be appreciated that print data 210 may be provided from local and/or remote sources.

The print control system 200 may also include a print job processor 250 that provides the second set of print data (e.g., the print job 230) to a transmitter or a set of communication components for transmission to an image forming device. The print job processor 250 may be, for example, a logic. The print job processor 250 may be configured to be responsible for actions like communicating the print job 230 to an image forming device, for querying and/or receiving status information about downstream components, and/or for saving states to a memory 240. Thus, in one example, the print job processor 250 includes a query logic 254 for querying one or more downstream components for status associated with the transmission of and/or the forming of the second set of print data (e.g., print job 230) into an image on an image forming device. The print job processor 250 may also include a state saving logic 256 for storing information concerning the transmission of and/or the downstream processing of the second set of print data. By way of illustration, the query logic 254 may periodically and/or under user or programmatic control transmit a “status query” to an image forming device and/or one or more downstream components. If the image forming device replies by transmitting a useable status or state, the query logic 254 may interact with the state saving logic 256 to store the status and/or state of the downstream component(s) in memory 240. Thus, determining when and/or how to reprocess print data after an interruption (e.g., loss of signal) is facilitated.

The print job processor 250 may also include a resume logic 252 for selectively providing a subset of the second set of print data to a transmitter for retransmission to an image forming device. The resume logic 252 may determine and/or receive a notification of a “priming event” like a transmission being interrupted (e.g., loss of signal, battery low, incoming call). The resume logic 252 may also determine and/or receive a notification of a “triggering event” like a transmission once again being possible (e.g., signal returned, battery recharged, incoming call terminated). The resume logic 252 may be operably connected to, for example, a resuming event detector 270 to facilitate identifying when to control the print job processor 250. Additionally and/or alternatively, the resume logic 252 may determine that while a print job 230 was successfully transmitted, that a downstream component lost a portion of the transmission (e.g., printer jammed and page three was lost). The resume logic 252 may therefore query the memory 240 to acquire state information about the print job 230, the transmission of the print job 230, zero or more downstream components, and so on. Then, based at least in part on that state information, the resume logic 252 may determine when and/or how to retransmit the print job 230. By way of illustration, the resume logic 252 may determine that the entire print job 230 needs to be retransmitted. Thus, the resume logic 252 may control the print job processor 250 and/or a transmitter (not illustrated) to retransmit the entire print job 230. By way of further illustration, the resume logic 252 may determine that the third page of five pages needs to be retransmitted. Thus, the resume logic 252 may control the print job processor 250 and/or a transmitter to retransmit a portion of the print job 230 (e.g., third page). Having the ability to re-process portions of a print job rather than the entire print job may reduce processing and transmission time.

The print control system 200 may include a saving event detector 260. The saving event detector 260 can be configured to determine when a state associated with preparing the print data 210 and/or transmitting the print job 230 should be stored in the memory 240. The saving event detector 260 may be operably connected to, for example, the state saving logic 256 to facilitate saving a state. A user may manually indicate that a state should be saved when, for example, an outgoing call is to be made that may interrupt print data processing. Similarly, the print control system 200 may indicate that a state should be saved when, for example, it determines that an incoming call is received that may interrupt processing. Other state saving events can include, but are not limited to, loss of communication signal, low battery, a processing condition (e.g., x % of data prepared/transmitted), receipt of a “pause” indication from a downstream component, a time interval, and so on. The saving event detector 260 may be, for example, a logic.

The print control system 200 may also include a resuming event detector 270. The resuming event detector 270 can be configured to determine when the print job processor 250 should control the cellular telephone to selectively retransmit a subset of the print job 230 or to reprocess a subset of the set of print data 210. For example, the resuming event detector 270 may determine that a transmission of the print job 230 was halted due to an incoming call, that the incoming call completed, and that processing of the print job 230 can resume. The resuming event detector 270 may be, for example, a logic.

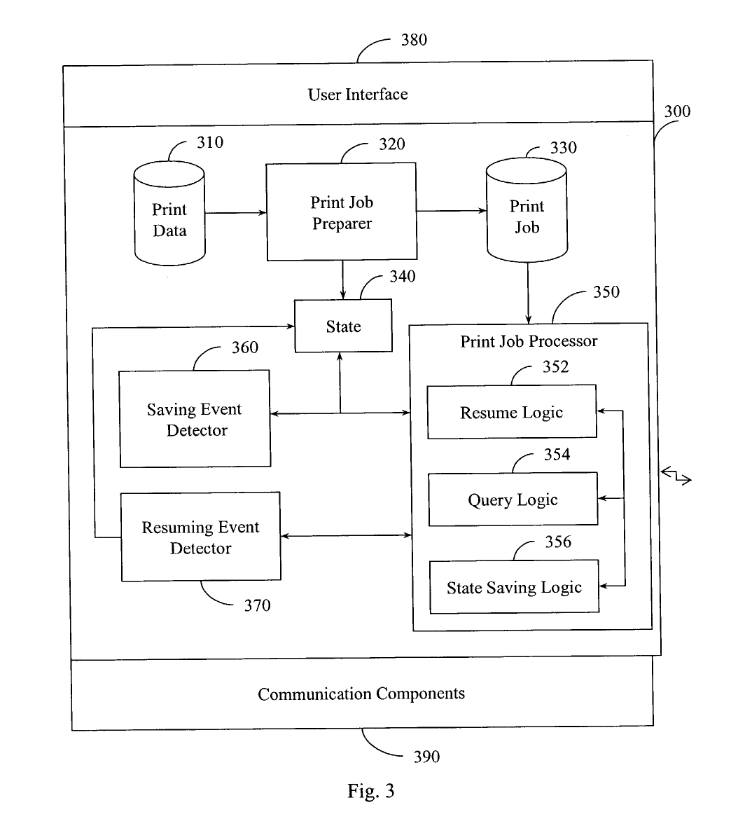

There are opportunities for configuring parameters associated with components like the print job processor 250, the print job preparer 220, the saving event detector 260, the resuming event detector 270 and so on. Thus, FIG. 3 illustrates an example printer control system 300 associated with a cellular telephone that includes a user interface 380 configured to facilitate establishing one or more parameters associated with one or more of a memory 340, a print job preparer 320, a saving event detector 360, a resuming event detector 370, and a print job processor 350 and/or its subcomponents. By way of illustration, parameters describing what type of events are to be considered state saving events may be managed. FIG. 3 also illustrates communication components 390 (e.g., wireless transceiver) that can be employed to transmit the print job 330 and/or receive status information from one or more downstream components.

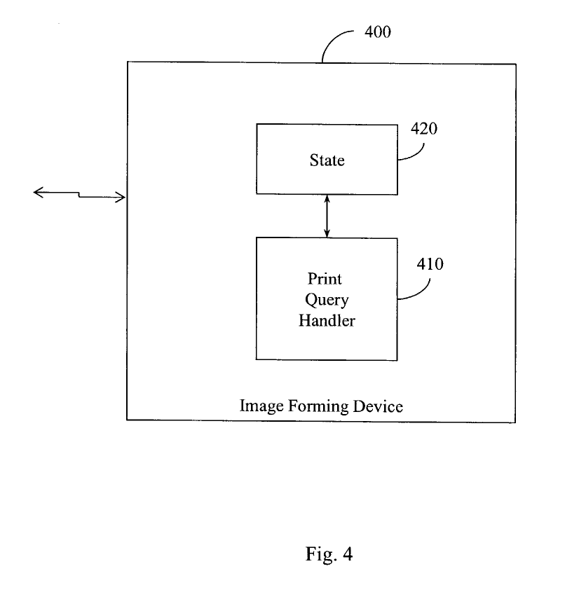

FIG. 4 illustrates an example image forming device 400 that may interact with a print-enabled cellular telephone. In one example, the image forming device 400 can be configured to maintain and provide data to a cellular telephone that may assist the cellular telephone to recover and resume an interrupted or otherwise incomplete print job. The image forming device 400 includes a memory 420 for storing state information associated with one or more print jobs received from one or more cellular telephones. While a memory 420 is illustrated, the state may also be stored, for example, in a data store. The state information may include information about a percentage of a print job that has been received from a cellular telephone, the percentage of a print job that has been printed, identification data that associates a print job state to its corresponding cellular telephone, and so on. This state information may be requested by or transmitted to a cellular telephone to facilitate determining that a retransmission situation exists and/or how to handle a retransmission situation.

Thus, the image forming device 400 may also include a cellular telephone print query handler 410 configured to receive a query for the state associated with the cellular telephone set of print data. The cellular telephone print query handler 410 may also be configured to provide one or more elements of the state associated with the cellular telephone set of print data. The cellular telephone print query handler 410 may be implemented, for example, as a logic. The cellular telephone print query handler 410 may also be configured to initiate the transmission of the state 420 to the associated cellular telephone without receiving a query. For example, one or more elements of the state 420 can be automatically transmitted based on predetermined triggering events like a time period elapsing, a processing event occurring, and/or other event occurring. In this manner, the image forming device 400 can provide automatic status updates to cellular telephones that have a print job being processed. It will also be appreciated that the print query handler 410 can also be configured to monitor and provide state information 420 for print data associated with multiple cellular telephones. For example, separate state information 420 can be maintained for each received set of print data and can be selectively transmitted to a corresponding cellular telephone to provide a status update.

The image forming device 400 may communicate with a cellular telephone via wireless communications, for example. Thus, the image forming device 400 may include a radio-frequency transceiver (not illustrated) for receiving a set of print data from a cellular telephone and/or for communicating state information stored in the memory 420 to the cellular telephone. While wireless communications via radio frequency are described, it is to be appreciated that in other examples of other communications (e.g., wired) via other methods (e.g., local area network) can be employed.

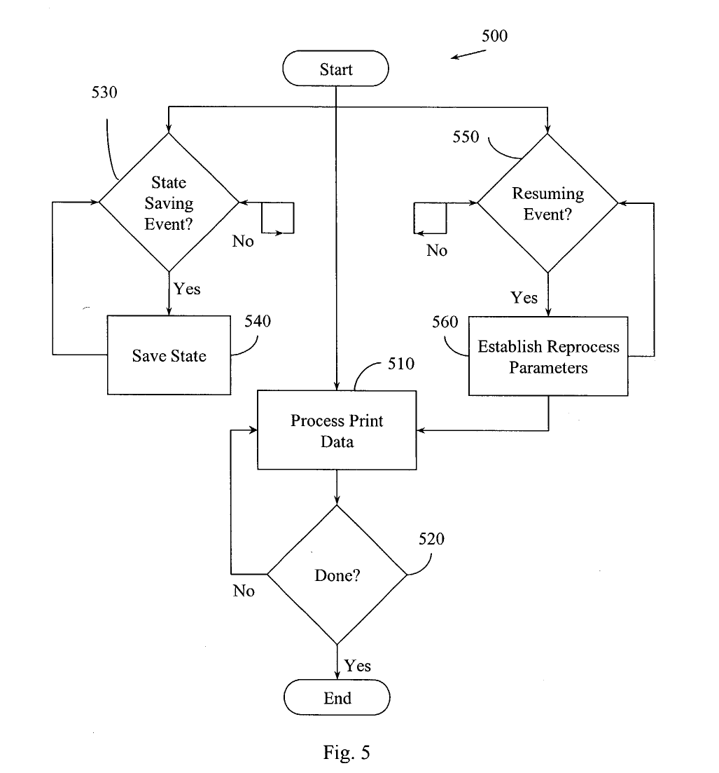

Example methods may be better appreciated with reference to the flow diagrams of FIGS. 5 through 7. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, the illustrated elements denote “processing blocks” that may be implemented, for example, in software. Additionally and/or alternatively, the processing blocks may represent functions and/or actions performed by functionally equivalent circuits like a digital signal processor (DSP), an application specific integrated circuit (ASIC), and the like.

A flow diagram does not depict syntax of any particular programming language. Rather, a flow diagram illustrates functional information one skilled in the art may employ to fabricate circuits, generate computer software, or use a combination of hardware and software to perform the illustrated processing. It will be appreciated that electronic and software applications may involve dynamic and flexible processes such that the illustrated blocks can be performed in other sequences different than the one shown and/or blocks may be combined or, separated into multiple components. They may also be implemented using various programming approaches such as machine language, procedural, object oriented and/or artificial intelligence techniques.

FIG. 5 illustrates an example method 500 associated with processing print data in a cellular telephone. The method 500 may include, at 510, processing print data. Processing print data can include, for example, preparing print data into printer ready bits, instructions, and so on, and may also include transmitting those printer ready bits, instructions, and so on to an image forming device or other communication components or devices for delivery to an image forming device.

The method 500 may also include, at 530, monitoring a cellular telephone for a state saving event while the cellular telephone is processing (e.g., preparing, transmitting) a set of print data. If a state saving event is detected at 530, then the method 500 will, at 540, selectively store a state associated with processing the set of print data based, at least in part, on the state saving event. For example, if a state saving event like an incoming call is detected, then the state saved at 540 may include information about the status of print data transmitting and the reason for transmission interruption.

The method 500 may also include, at 550, monitoring a cellular telephone for a resuming event while the cellular telephone is processing (e.g., preparing, transmitting) a set of print data. In response to a resuming event being detected, at 560, the method 500 may selectively cause the cellular telephone to reprocess a subset of the set of print data based, at least in part, on the state and/or one or more reprocessing parameters. In one example, reprocessing a subset of the set of print data is facilitated by the method 500 establishing one or more reprocessing parameters like where processing was halted and where reprocessing should begin. Reprocessing parameters may be established upon the receipt of various types of resuming events. A resuming event may be associated with an interruption (e.g., loss of signal) that generates the situation where resuming is required and/or a clearing condition (e.g., signal returned) that can serve as the trigger for resuming processing. For example, if a first resuming event (e.g., interrupting event) like an incoming call being received is detected at 550, then, reprocessing parameters associated with how much data was processed and how much data need to be reprocessed can be established. Then, if a second resuming event (e.g., clearing event) like the incoming call being terminated is detected at 550, then, the reprocessing parameters can be examined to facilitate determining how to continue processing the print data at 510.

In one example of method 500, state saving events may include, but are not limited to, receiving a user indication that state should be saved, receiving a programmatic indication that state should be saved, a time period elapsing, a processing event occurring, a loss of signal occurring, a low battery occurring, print data entering a logic in the cellular telephone, print data leaving a logic in the cellular telephone, and a state saving signal being received by the cellular telephone. It is to be appreciated that these are example state saving events and that other state saving events may also be detected and processed. By way of illustration, in a first system a time period can be established (e.g., 1 second) so that state is saved every second during print data processing. By way of further illustration, in a second system state may be saved when a user determines to save state. In the first system, the time period may be user configurable via, for example, a user interface.

In one example of method 500, the occurrence of a processing event may be related to a pre-determined, configurable amount of print data being prepared for transmission to an image forming device. In one example, state may be saved when a pre-defined number of units of data (e.g., message, page, block) are prepared. In another example, state may be saved when a pre-defined amount of print data (e.g., 5%, 10%, 15%, . . . ) is prepared. In another example, the occurrence of a processing event may be related to a pre-determined, configurable amount of print data being transmitted to an image forming device. By way of illustration, state may be saved when a pre-defined number of units of data (e.g., bytes, files) or blocks (e.g., divs) are transmitted, while in another example state may be saved when a pre-defined amount of a print job (e.g., 2%, 4%, 6%, . . . ) is transmitted. Based on the saved state, the reprocessing parameters can be generated/updated to represent a completeness of the print job during processing, transmission, and/or processing by an image forming device.

Resuming events may include, but are not limited to, a user indication that processing should resume, a programmatic indication that processing should resume, a time period elapsing, a loss of signal occurring, a signal being reacquired, a low battery occurring, a battery strength returning, and a resume signal being received by the cellular telephone. By way of illustration, a cellular telephone like a camera-enabled cellular phone may be able to monitor its strength of signal. If the device determines that the signal strength has fallen below an acceptable level and that the device was transmitting a print job, then the device may generate a resuming event that can be detected by the method 500. In this example, resuming events may have a priming component (e.g., loss of signal) and a triggering component (e.g., signal being reacquired).

It is to be appreciated that the method 500, and other example methods may be stored, transmitted, distributed, and the like on a computer readable media. Thus, a computer-readable medium may store computer/processor executable instructions operable to perform the example method 500 and other methods described herein.

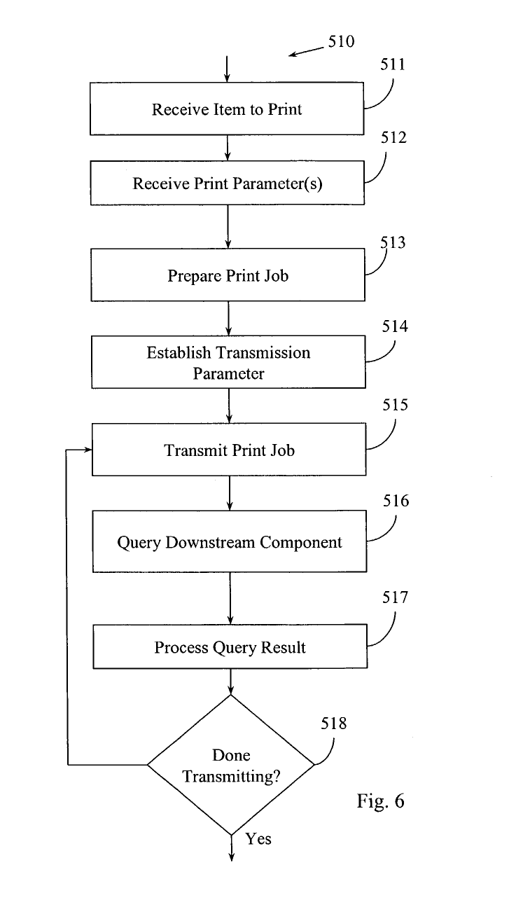

FIG. 6 illustrates an example of the portion 510 of example method 500 associated with processing print data in a cellular telephone. The method 510 includes, at 511, receiving an item to print. The item to print may be, for example, a file, a message, an email, an object, and so on. The portion 510 receives, at 512, one or more print parameters associated with the item to print. Print parameters may include, but are not limited to, a number of copies to print, a print quality, a print size, a print speed, a print orientation, a print time, and a print location. Print parameters may be set by, for example, default settings, user selection, or the like.

The method may also include, at 513, preparing a print job from the item to print where the preparing may be controlled, at least in part, by the print parameter(s). This may include, for example, rendering the item to print into printer ready bits, doing content transformation on the item to print so that the print job contains printer ready instructions, and/or preparing printer-independent data like vCard or vCal data. The rendering, content transformation, and so on may be controlled, for example, by the print parameter(s). For example, a print parameter that specifies a first printer as a destination printer may cause the item to print to be rendered into a first format while a print parameter that specifies a second printer as a destination printer may cause the item to print to be content transformed into a second format while a print parameter that specifies a display as a destination device may cause the item to print to be content transformed in a third manner.

The method may also include, at 514, establishing one or more transmission parameter(s). Transmission parameters may include, but are not limited to, a transmission speed, a transmission size, a transmission time, a transmission quality, a transmission media, a transmission destination, and a transmission protocol. At 515, the print job is transmitted. The transmission is controlled, at least in part, by the transmission parameter(s). For example, a transmission parameter may indicate that a first print job is to be transmitted via a first protocol (e.g., TCP/IP) while a second print job is to be transmitted via a second protocol.

During transmission, various transmitting interrupting events may occur. For example, an incoming call may be detected, the battery on a transmitting cellular telephone may go low, a signal strength may dip below an acceptable threshold and so on. Thus, the method may include selectively retransmitting one or more portions of the print job according to a retransmission parameter(s). Retransmission parameters may include, but are not limited to, a transmission speed, a transmission size, a transmission time, a transmission quality, a transmission media, a transmission destination, a transmission protocol, a retransmission start point, a retransmission size, and a retransmission end point. By way of illustration, the method 500 may be tracking units of the print job that have been transmitted. When an interruption occurs during transmission, the method may store information identifying the last unit of the print job that was transmitted, which facilitates identifying an appropriate retransmission location.

The method may also include, at 516, transmitting a query to a downstream component for information associated with the transmitted print job. For example, the method may send a query to an image forming device seeking information concerning whether the transmitted print job was received and/or formed into an image. Similarly, the method may send a query to a store and forward downstream component seeking information concerning which units, if any, have been successfully stored. Thus, the method also includes, at 517, receiving a response to the query and establishing a retransmission parameter based, at least in part, on the response to the query. For example, if the downstream component reports that units one, two and four of a four part print job were successfully stored, then the method may establish a retransmission parameter that identifies that unit three needs to be retransmitted. The transmission process ends if the transmission of the print job is complete at 518. Otherwise, the transmission continues at 515.

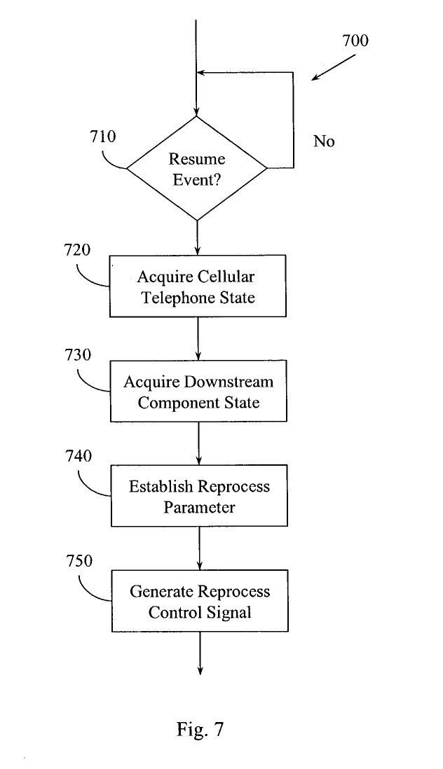

FIG. 7 illustrates a portion 700 of an example method associated with processing print data in a cellular telephone. The portion 700 relates to a print job recovery method. The print job recovery method can include, at 710, monitoring a cellular telephone for an indication that a print job should be reprocessed. When an indication is received, the portion 700 includes, at 720, acquiring the state of the cellular telephone and, at 730, selectively acquiring the state of one or more downstream components and/or image forming devices. Thus, in the example, the method has information concerning both the cellular telephone that is sending a print job to an image forming device, the downstream component(s), and the printer(s) to which the print job is being sent. It is to be appreciated that in some examples the downstream component(s) and/or printer(s) will not be able to convey state information back to the method, and thus the method can make subsequent determinations based on the state of the cellular telephone.

The portion 700 also includes, at 740, establishing a reprocessing parameter based, at least in part, on the state of the cellular telephone and the state of the downstream components. As described above, the reprocessing parameter may be established on the state of the cellular telephone if the downstream component(s) and/or image forming device(s) do not provide state information. The reprocessing parameter may be, for example, an identifier that identifies which portion(s) of a print data need to be reprocessed. At 750, the portion 700 generates a reprocess control signal that can be employed to control reprocessing (e.g., rendering, transmitting) of the print data.

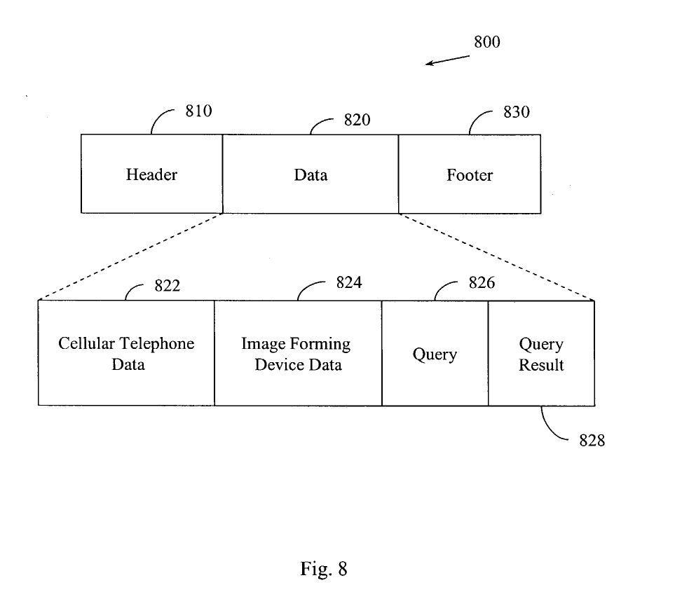

FIG. 8 illustrates an example data packet 800 associated with processing cellular telephone print data. Information can be transmitted between various logics and/or communication components associated with cellular telephone print job recovery via a packet like data packet 800. Example data packet 800 includes a header field 810 where information like the length and type of data packet 800 may be stored. The header field 810 may also include, for example, a source identifier that identifies, for example, a network or other address of the source of the data packet 800. The header field 810 may also include, for example, a destination identifier that identifies, for example, a network or other address of the intended destination for the packet 800. Thus, the header field 810 may include, in one example, a cellular telephone address associated with a cellular telephone from which a print job is originated and a network address of a printer to which the print job is to be delivered. It is to be appreciated that the source and destination identifiers may take forms including, but not limited to, globally unique identifiers (guids), uniform resource locations (URLs), path names, and so on. Other types and forms of information can be included in the data packet that can depend on the communication protocol being employed.

The data field 820 may include various information intended to be communicated between the source and destination. Example fields 822 through 828 are provided. By way of illustration, data associated with a cellular telephone may be stored in field 822. This data may be, for example, state information associated with the cellular telephone. Similarly, field 824 may store information about an image forming device like capabilities and state. Field 826 may store, for example, a query code from the cellular telephone that indicates what type of information the cellular telephone is requesting from an image forming device. Thus, in one example, field 828 may store information responsive to the query. Fields 826 and 828 may be referred to collectively as fields that store query data. While four data fields are illustrated, it is to be appreciated that a greater and/or lesser number of data fields may be provided. Similarly, while three fields are shown in packet 800, a greater and/or lesser number of fields may be employed. Data packet 800 may also include a footer field 830. The footer field 830 may store information like error detecting and/or correcting information whereby a receiving logic and/or communication component can determine whether it correctly received data packet 800.

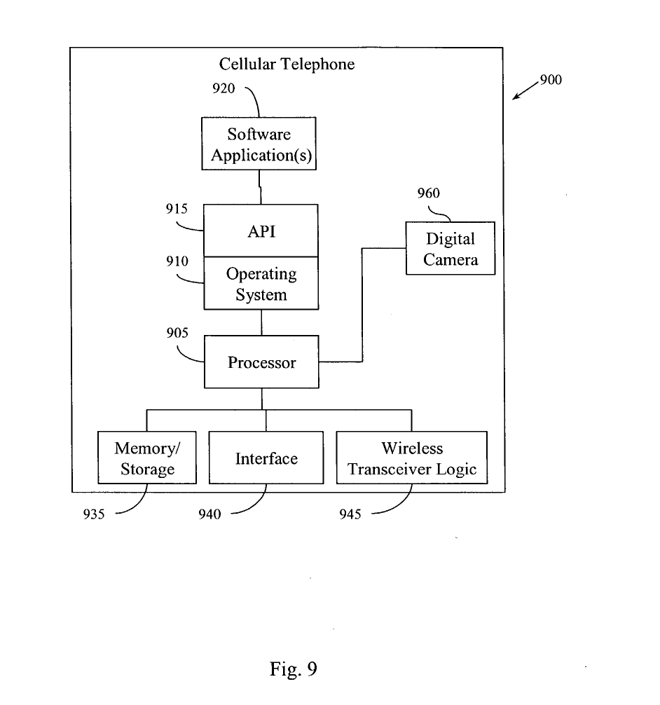

FIG. 9 illustrates an example cellular telephone 900. The cellular telephone 900 may include a processing system that has, for example, a processor 905, an operating system 910, and an application program interface (API) 915 to provide communication between one or more software applications 920, and the operating system 910. The processing system of the cellular telephone 900 can be configured to execute a variety of software applications 920. One such application may be a print job recovery method. Other components of the cellular telephone 900 may include memory and/or storage 935 that can include a computer-readable medium. The storage 935 may also include a port that accepts and reads data stored on a removable memory card or other removable computer-readable medium. An interface 940 can include a display screen, one or more buttons, a pointing device, or other types of devices that can communicate data to a user and receive input from a user. To perform wireless communication, a wireless transceiver logic 945 is provided. Depending on the wireless communication protocol desired, the transceiver logic 945 can be configured according to different specifications.

In one example, the wireless protocol is Bluetooth and the transceiver logic 945 would include a Bluetooth radio and antenna. Other protocols include IEEE 802.11 and other available wireless protocols. In one example, the wireless transceiver logic 945 includes a radio frequency transceiver configured to transmit and receive radio frequency signals. Infrared communication can also be used. The transceiver logic 945 may be, for example, a microchip in the cellular telephone 900 or configured on a removable device like a PCMCIA card (PC card) that can be connected and disconnected to the cellular telephone 900 via a connection port or slot. In one example, the cellular telephone 900 includes a digital camera 960 and a cellular phone 965, also referred to as a camera-enabled phone.

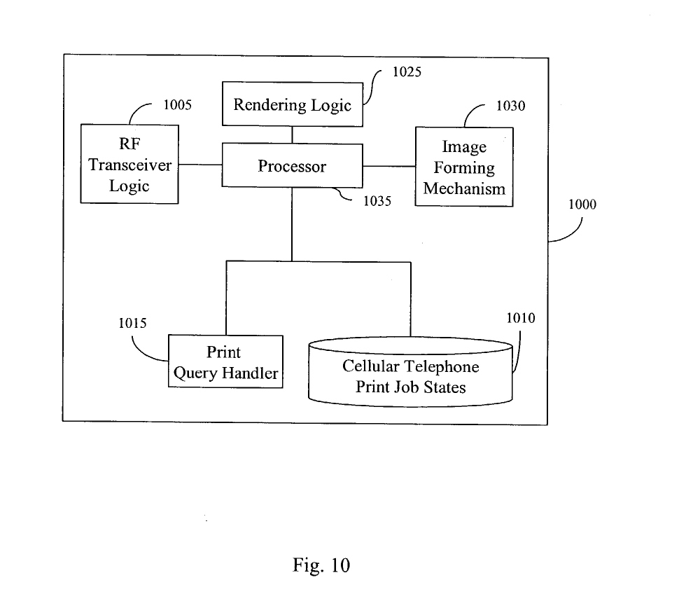

FIG. 10 illustrates an example image forming device 1000 that includes a compatible RF transceiver logic 1005. The image forming device 1000 may include a memory configured to store state information 1010 associated with processing one or more print jobs received from one or more cellular telephones. This may be configured in a similar manner as the memory 420 shown in FIG. 4. The image forming device 1000 may also include a print query handler 1015 configured to respond to state queries from cellular telephones relating to their corresponding print job. The query handler 1015 may be similarly configured as the query handler 410 shown in FIG. 4.

Additionally, the image forming device 1000 may include rendering logic 1025 configured to generate a print-ready image from an imaging request. Rendering varies based on the format of the data involved and the type of imaging device. In general, the rendering logic 1025 converts a high-level object-based description (e.g., the imaging request) into a graphical image for display or printing (e.g., the print-ready image). For example, one form is ray-tracing that takes a mathematical model of a three-dimensional object or scene and converts it into a bitmap image. Another example is the process of converting HTML into an image for display/printing. In another example, the image forming device 1000 may not have a rendering logic 1025. In this case, a print job would be transmitted to the image forming device 1000 in a print ready format.

The image forming device 1000 may also include an image forming mechanism 1030 configured to generate an image onto print media from the print-ready image. The image forming mechanism 1030 will vary based on the type of imaging device and may include a laser imaging mechanism, other toner-based imaging mechanisms, an ink jet mechanism, digital imaging mechanism, or other imaging reproduction engine. A processor 1035 may be included that is implemented with logic to control the operation of the image-forming device 1000. In one example, the processor 1035 includes logic that is capable of executing Java instructions. Other components of the image forming device 1000 are not described here but may include media handling and storage mechanisms, sensors, controllers, and other components involved in the imaging process.

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on employed in print job control on a cellular telephone. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A print control system for a cellular telephone, comprising:
a memory configured to store a state associated with the cellular telephone processing a set of print data; and
a print control logic configured to control the cellular telephone to selectively reprocess a subset of the set of print data based, at least in part, on the state.

2. The system of claim 1, where processing a set of print data comprises one or more of, preparing the set of print data to be transmitted to an image forming device, and transmitting the set of print data to an image forming device.

3. The system of claim 2, where the state comprises information concerning one or more of, an extent to which the set of print data has been prepared for transmitting to an image forming device, an extent to which the set of print data has been transmitted to an image forming device, and an extent to which the set of print data has been formed into an image by an image forming device.

4. The system of claim 3, where the state comprises information concerning the status of one or more downstream components associated with forming the print data into an image by an image forming device.

5. The system of claim 1, comprising:
a saving event detector configured to determine when a state associated with the cellular telephone processing a set of print data should be stored in the memory.

6. The system of claim 1, comprising:
a resuming event detector configured to determine when the print control logic should control the cellular telephone to selectively reprocess a subset of the set of print data.

7. The system of claim 1, comprising:
a print job preparer configured to receive a set of print data that is to be prepared to transmit to an image forming device and further configured to produce a print job from the print data, where the print job is to be transmitted to an image forming device.

8. The system of claim 7, comprising:
a print job processor configured to provide the print job to a transmitter for transmission to an image forming device.

9. The system of claim 8, where the print job processor comprises:
a query logic configured to query one or more downstream components for status information associated with forming the print job into an image by an image forming device.

10. The system of claim 8, where the print job processor comprises:
a state saving logic configured to store information in the memory concerning transmitting the print job.

11. The system of claim 8, where the print job processor comprises:
a resume logic configured to selectively provide a subset of the print job to a transmitter for retransmission to an image forming device.

12. The system of claim 11, comprising:
a user interface configured to facilitate managing one or more parameters associated with one or more of, the memory, the print job preparer, the print job processor, the resuming event detector, the saving event detector, and the print control logic.

13. The system of claim 1, comprising:
one or more communication components configured to transmit the set of print data to an image forming device.

14. An image forming device, comprising:
a memory configured to store a state associated with a cellular telephone set of print data; and
a print query handler configured to provide one or more elements of the state associated with the cellular telephone set of print data to a cellular telephone.

15. The image forming device of claim 14, where the print query handler is configured to provide the one or more elements of the state in response to a received query from a cellular telephone.

16. The image forming device of claim 14, where the print query handler is configured to automatically transmit the one or more elements of the state to a cellular telephone based on one or more triggering events.

17. The image forming device of claim 14, comprising:
a radio-frequency transceiver configured to receive a set of print data from a cellular telephone.

18. A method, comprising:
monitoring a cellular telephone for a state saving event while the cellular telephone is processing a set of print data;
in response to the state saving event, selectively storing a state associated with processing the set of print data based, at least in part, on the state saving event;
monitoring the cellular telephone for a resuming event while the cellular telephone is processing a set of print data; and
in response to the resuming event, establishing one or more reprocessing parameters and selectively causing the cellular telephone to reprocess a subset of the set of print data based, at least in part, on the reprocessing parameters.

19. The method of claim 18, where the state saving event is one or more of, receiving a user indication that a state should be saved, receiving a programmatic indication that a state should be saved, a time period elapsing, a processing event occurring, a loss of signal occurring, a low battery occurring, print data entering a logic in the cellular telephone, print data leaving a logic in the cellular telephone, and a state saving signal being received by the cellular telephone.

20. The method of claim 19, where the processing event occurring is related to a pre-determined, configurable amount of print data being prepared for transmission to an image forming device.

21. The method of claim 19, where the processing event occurring is related to a predetermined, configurable amount of print data being transmitted to an image forming device.

22. The method of claim 19, where the time period is user configurable.

23. The method of claim 18, where the resuming event is one or more of, a user indication that processing should resume, a programmatic indication that processing should resume, a time period elapsing, a loss of signal occurring, a signal being reacquired, a low battery occurring, a battery strength level being re-established, and a resume signal being received by the cellular telephone.

24. The method of claim 18, where the processing of the set of print data includes transmitting the set of print data to an image forming device.

25. A computer-readable medium storing processor executable instructions operable to perform the method of claim 18.

26. A method for processing print data associated with a cellular telephone, comprising:
receiving an item to print;
receiving a print parameter associated with the item to print;
preparing a print job from the item to print based, at least in part, on the print parameter;
establishing a transmission parameter;
transmitting the print job to an image forming device according to the transmission parameter; and
selectively retransmitting one or more portions of the print job to the image forming device according to a retransmission parameter.

27. The method of claim 26, comprising:
transmitting a query to a downstream component for information associated with the transmitted print job;
receiving a response to the query; and
establishing a retransmission parameter based, at least in part, on the response to the query.

28. The method of claim 26, where the print parameter is one or more of, a number of copies to print, a print quality, a print size, a print speed, a print orientation, a print time, and a print location.

29. The method of claim 26, where the transmission parameter is one or more of, a transmission speed, a transmission size, a transmission time, a transmission quality, a transmission media, a transmission destination, and a transmission protocol.

30. The method of claim 26, where the retransmission parameter is one or more of, a transmission speed, a transmission size, a transmission time, a transmission quality, a transmission media, a transmission destination, a transmission protocol, a retransmission start point, a retransmission size, and a retransmission end point.

31. The method of claim 26, where the retransmission parameter represents a completeness of the print job.

32. A print job recovery method, comprising:
monitoring a cellular telephone for an indication that a print job can be reprocessed;
upon receiving the indication, acquiring a state of the cellular telephone and selectively acquiring a state of one or more downstream components;
establishing a reprocessing parameter based, at least in part, on the state of the cellular telephone and the state of the downstream components; and
generating a reprocess control signal.

33. A mobile phone print job recovery system, comprising:
a print-enabled mobile phone;
a print job processor configured to prepare a set of print data for transmission from the print-enabled mobile phone to a printer;
a print job transmitter configured to transmit the set of print data to a printer;
a memory configured to store one or more states associated with one or more of preparing and transmitting the print data;
a state save logic configured to determine that a state should be saved and to initiate saving state to the memory;
a resume logic configured to determine that processing has been interrupted and to initiate reprocessing; and
a query logic configured to query a printer about one or more of, a status of a transmitted set of print data and a printer.

34. A system for processing print data from a cellular telephone, comprising:
an image forming device configured to accept print data from a camera enabled cellular phone by a wireless communication protocol; and
a camera enabled cellular phone, comprising:
a wireless transceiver logic configured to communicate print data in accordance with the wireless communication protocol, the wireless transceiver logic also configured to receive status information from the image forming device;
a print controller configured to store a phone state associated with the camera enabled cellular phone processing of a print data, the print controller also configured to store an image forming device state associated with the image forming device forming an image from the received print data; and
a print control logic configured to control the camera enabled cellular phone to selectively reprocess a subset of the set of print data based, at least in part, on the state.

35. A data packet for transmitting print job recovery data between a cellular telephone and an image forming device, comprising:
a first field that stores cellular telephone data;
a second field that stores image forming device data; and
a third field that stores a query data.
